(19) United States
(12) Patent Application Publication
(10) Pub. No.: US 2010/0201076 A1
(43) Pub. Date: Aug. 12, 2010

(54) Segmented packing ring

(75) Inventors: Christian Hold, Bisamberg (AT); Tino Lindner-Silwester, Wien (AT); Alexander Jandl, Rohrendorf (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: HOERBIGER KOMPRESSORTECHNIK HOLDING GMBH

(21) Appl. No.: 12/656,422

(22) Filed: Jan. 28, 2010

(30) Foreign Application Priority Data
Jan. 29, 2009 (AT) A153/2009

(51) Int. Cl. F04B 53/00; F16J 15/16

(52) U.S. Cl. 277/543

(57) ABSTRACT

A segmented packing ring 20 includes a number of first sealing segments 21, a number of second sealing segments 22, and a number of support segments 23, the support segments 23 and the second sealing segments 22 being arranged in an alternating successively abutting manner in the circumferential direction, and the first sealing segments 21 being arranged in a manner axially abutting the second sealing segments 22 and the support segments 23, and including a nose 24 extending axially on the second sealing segments 22, which is arranged in the circumferential direction between two adjacent first sealing segments 21.

### BACKGROUND OF THE INVENTION

Piston compressors, particularly single-acting ones, require sealing along the oscillating piston rod 5. The sealing typically must be carried out against the (low) ambient pressure pᵤ being present in the crankcase. Referring to FIGS. 1-3, the sealing elements being utilized in such a seal 4 are called packing rings 6, 7, and are arranged in a so-called pressure packing 2, usually consisting of a number of packing rings 6, 7, such as illustrated in FIG. 1 in a common design by way of example. For this purpose the sealing elements may follow inevitable lateral movements of the piston rod 5 without losing the sealing effect thereof. In order to increase life and reliability of a pressure packing 2, a plurality of such packing rings 6, 7 are switched in series in a pressure packing 2. For this purpose the packing rings 6, 7 may be arranged in the pressure packing 2 in a chamber disk 10. In order to prevent an extrusion of a packing ring 7 in the annular gap between the piston rod 5 and the chamber disk 10 (particularly at which packing ring materials, or at high pressures), a support ring 8 may additionally be provided in the pressure packing 2. Usually, multiple pressure packings 2 are successively added in a seal 4. Such pressure packings 2 or seals 4 are commonly known in various embodiments according to the prior art, such as from GB 928/749 A, or from U.S. Pat. No. 1,008,655 A.

Packing rings 6, 7 are self-actuating seals, which usually require a certain pressure difference p₁-p₂ (FIG. 1c) for a sufficient sealing effect, e.g. for a sufficiently small risk of leakage. The gas pressure in a packing chamber 3 is built up in the gaps of a packing ring 6, 7 to be sealed from the highest level p₁ to the lower level p₂ in the nest packing chamber 3. FIG. 1c schematically shows such decrease in pressure in the seal gap between the packing ring 6, 7 and the piston rod 5. The seal gap plays a key role with regard to the performance of the packing rings 6, 7, since the relative movement of the contact surfaces between the piston rod 5 and the rings 6, 7 causes wear and tear on the packing rings 6, 7. Said ring wear usually warrants cut ring shapes, which enable a self-actuated continuous readjusting of the ring with the material removal on said seal gap ring/piston rod. For this purpose the industrial standard in rings 6, 7 is radially and tangentially cut rings being inserted into the packing chambers of the pressure packing in pairs in order to reciprocally cover the impact gaps toward the consumables compensation which have occurred, as schematically illustrated in FIG. 1b. In case of cut ring shapes tubular springs (circumferential springs) 9 that are wound across the outer circumference are commonly utilized, which press the packing rings 6, 7 against the piston rod 5, even in a depressurized state.

In a combination of a radially and a tangentially cut packing ring the sealing toward the piston rod is carried out essentially only by means of the tangentially cut packing ring, the ring segments of which may slide together by means of the tangential type of cut in case of wear, thus continuing the sealing effect. The radially cut packing ring essentially serves only to seal the wear gap of the tangential packing ring in axial direction, and is therefore subject only to little wear during the initial running-in phase. The radial packing ring shows wear only up to the point at which the ring segments are positioned adjacent to each other in circumferential direction. The radially and tangentially cut packing rings therefore show varying degrees of wear. In addition to the circumstance that the tangentially cut ring always shows quicker wear due to the larger surface adjustment than the radially cut one, the tangential ring typically also has an uneven wear pattern in circumferential direction, which may be accompanied by an opening of the tangential cuts and therefore a significantly increased leakage. In this manner such a ring may lose a large degree of the sealing effect thereof, even if the same has not yet reached the wear stop thereof (as opposed to the consumables compensation gap). Furthermore, a packing ring combination made from radially and tangentially cut packing rings requires elastic deformations of the ring segments with increasing wear in order to be able to maintain the sealing effect. In this regard only those materials are suitable for such packing ring combinations, which allow respective elastic deformations.

JP 05-044850 A1 has already suggested the use of a six-part segmented seal ring, which has three sealing segments embodying a continuous sealing surface on the radial interior. The sealing segments abut wedge-shaped support segments that are arranged there between. With the wear of the sealing segments the sealing segments move radially toward the interior and glide along the support segments, which essentially remain in the same position. Such a seal ring may therefore be subjected to a very high degree of wear without losing the sealing effect thereof. For this purpose the rate of wear, apart from the pressures present, essentially only depends on the ring material or on the material combination of the ring/piston rod selected, and may therefore be very high such that the seal ring may show wear rather quickly. The seal ring must therefore be exchanged in a timely manner before the sealing segments have too much wear, thus possibly resulting in damage or even destruction due to the mechanical and/or thermal stresses. However, since the actual wear cannot be seen from the outside, the seal must be checked periodically, which is often also accompanied by a (premature) exchange of the seal rings. The life of the seal rings is therefore possibly not optimally utilized.

It is therefore one object of the present invention to remedy the problems stated above, particularly to provide a packing ring that may be subjected to a high degree of wear, which wears very slowly, and is capable of optimally utilizing the wear potential available.

### SUMMARY OF THE INVENTION

The problem is solved according to the invention in that a number of first sealing segments, a number of second sealing segments, and a number of support segments are provided, wherein the support segments and the second sealing segments are arranged in an alternating successively abutting manner in the circumferential direction, and the first sealing segments are arranged in a manner axially abutting the second sealing segments and the support segments, and a nose extending axially is provided on the second sealing segments, which is arranged in the circumferential direction between two adjacent first sealing segments. Utilizing this arrangement of the segments it is achieved that the sealing segments are relieved by another segment, thus reducing the rate of wear of the packing ring. Furthermore, the material of the sealing segments available may be greatly utilized for the formation of wear in this manner.

If a gap is provided in circumferential direction between an axial nose and the adjacent first sealing segments, a beak-in phase is created, in which the first sealing segments are pressed stronger against the counter sealing surface, whereby the sealing surface of the first sealing segments may be adjusted accordingly. In this manner a high degree of sealing effect of the packing ring is achieved from the beginning.

The sealing surface of the packing ring may be reduced, if the support segments are embodied with a larger interior radius, than the second sealing segments. Utilizing this measure the frictional heat caused by the packing ring may be reduced, by means of which less cooling power is required for the seal, or by means of which the packing ring may be utilized under more complex environmental conditions (pressure, relative speeds, etc.).

The rate of wear of the packing ring may be optimally adjusted in a simple manner, if the circumferential front surfaces of the support segments and of the second sealing segments are tilted as opposed to a radial. Said angle is a freely adjustable design parameter, by means of which the packing ring may be optimally adjusted to the respective use and specification. In a particularly advantageous manner the angle is selected such that the circumferential front surfaces of the axial nose taper in a wedge shape from the radial interior to the radial exterior.

In order to enable a full-surface contact of the first and the second sealing segments the circumferential front surfaces of the first sealing segments are advantageously tilted according to the wedge shape of the axial nose as opposed to a radial.

A radial groove for a single-acting packing ring may be realized very easily, if the axial width of the axial nose is smaller than the axial width of the first sealing segments, since the nose itself forms said groove in this case. In this manner a weakening of the first sealing segments by means of such a radial groove may be omitted.

The present invention is explained in further detail based on the schematic, exemplary, non-limiting FIGS. 1 to 11 illustrating advantageous embodiments.

### BRIEF DESCRIPTION OF THE DRAWINGS

FIG. 1 shows a known seal of a piston rod having radially and tangentially cut packing rings,

FIGS. 2 and 3 show different perspective views of a segmented packing ring according to the invention,

FIGS. 4 to 6 show different views of a segmented packing ring according to the invention,

FIG. 7 shows the use of a segmented packing ring according to the invention in a pressure packing of a piston compressor,

FIGS. 8 and 9 show different perspective views of a segmented packing ring according to the invention comprising pressure compensation, and

FIGS. 10 and 11 show sections across a segmented packing ring according to the invention comprising pressure compensation.

### DETAILED DESCRIPTION OF THE PREFERRED EMBODIMENTS

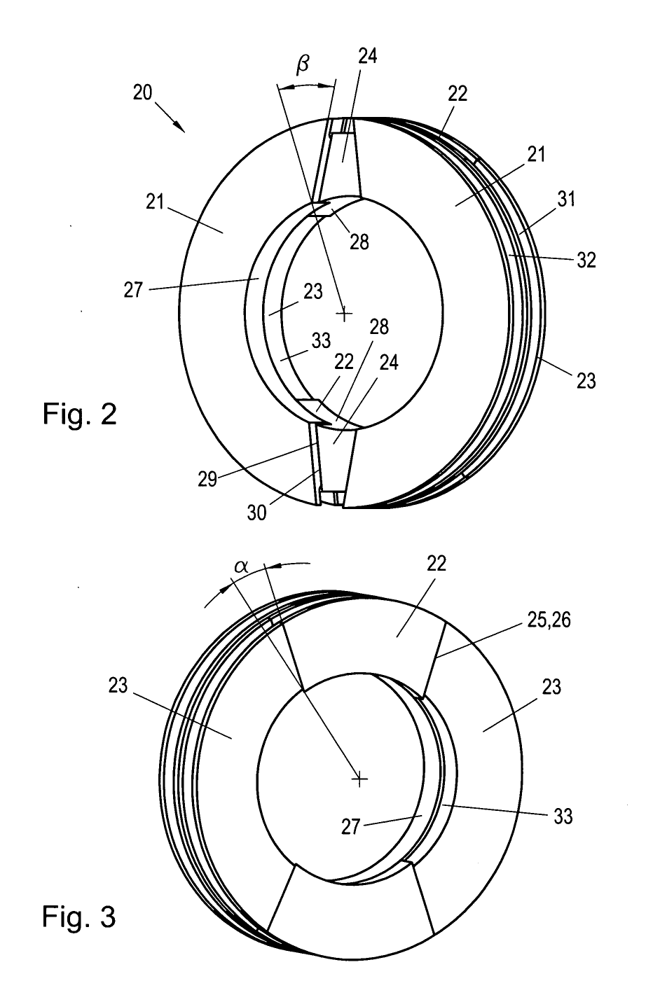

The perspective illustrations of a segmented packing ring 20 according to the invention in accordance with FIGS. 2 and 3 show the packing ring 20 from two different sides. The packing ring 20 consists of different ring segment-shaped segments, which together form the packing ring 20. Here, the packing ring 20 is formed from two first sealing segments 21, two second sealing segments 22, and two support segments 23. However, the packing ring 20 may also be embodied with more than two of the segments 21, 22, 23. The second sealing segments 22 and the support segments 23 abut each other in circumferential direction at the circumferential front surfaces 25, 26 thereof, wherein the support segments 23 and the second sealing segments are arranged in an alternating abutting manner. The first sealing segments 21 abut the second sealing segments 22 and the support segments 23 in an axial manner. Furthermore, an axial nose 24 is provided on the second sealing segments 22, which is arranged in circumferential direction between two adjacent first sealing segments 21. As commonly known, the individual segments 21, 22, 23 may be held together by means of (not illustrated) circumferential springs 9, which may be arranged in the circumferential grooves 31, 32 in the radial outer circumferential surfaces.

The first sealing segments 21 have a first sealing surface 27 positioned radially on the inside, which abuts an oscillating piston rod during operational use, and seals the same in axial direction. The second sealing segments 22 have a second sealing surface 28 positioned radially on the inside, which abuts an oscillating piston rod during operational use, and seals the same in axial direction. Thus a sealing surface that is closed in circumferential direction is formed by means of the first sealing surface 27 and the second sealing surface 28. The first sealing segments 21 further also overlap the joint formed between the second sealing segments 22 and the support segments 23 by means of the circumferential surfaces 25, 26, thus also sealing said joint in axial direction. In radial direction the sealing is carried out by means of the joint formed between the second sealing segments 22 and the support segments 23 by means of the circumferential surfaces 25, 26.

The circumferential front surfaces 29 of the axial noses 24 on the second sealing segments 22 may be tilted as opposed to a radial at an angle β by the center of the packing ring 20 such that the circumferential surfaces 29 taper from the radial interior toward the radial exterior in the manner of a wedge. The circumferential front surfaces 30 of the first sealing segments 21 are preferably arranged in a parallel manner such that a full-surface contact of the circumferential front surfaces 29, 30 is enabled. A gap may be provided between the circumferential front surfaces 29, 30 of the support segments and the second sealing segments 22 in circumferential direction such that the circumferential front surfaces 29, 30 do not abut each other equally.

The axial width of the axial nose 24 may also be smaller than the axial width of the first sealing segments such that the nose 24 slightly protrudes toward the interior in an axial manner as opposed to the free front surface of the first sealing segments 21. In this manner the noses 24 simultaneously also form a radially aligned groove at the front surface of the packing ring 20 for a single-acting packing ring 20. In case the nose 24 does not slightly protrude toward the interior a radial groove may also be provided on, the first sealing segment 21 on the free front surface in order to obtain a single-acting packing ring. Such a radial groove is not required for a double action packing ring.

The circumferential front surfaces 25, 26 of the second sealing segments 22 and the support segments 23 may be arranged in a tilting manner at an angle a as opposed to a radial. The support segments 23 have a circumferential surface 33 positioned radially toward the interior, which may have a greater radius than the sealing surface 27, 28 of the first and second sealing segments 21, 22 such that an annular gap is created on the support segments 23 on the radial interior. Such an annular gap decreases the sealing surface of the packing ring 20, and therefore also simultaneously the frictional heat created.

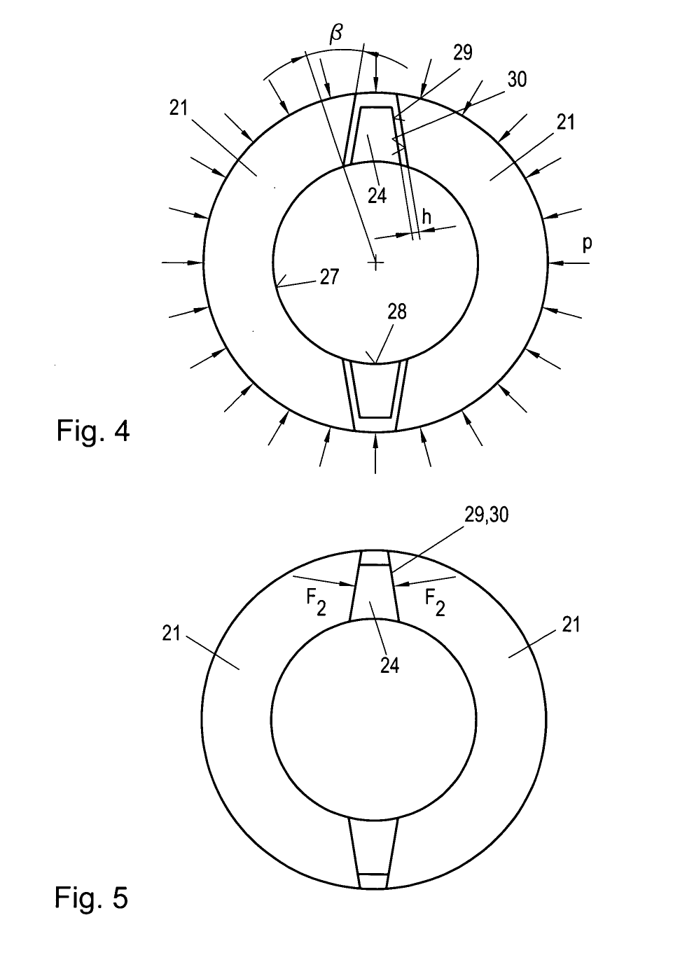

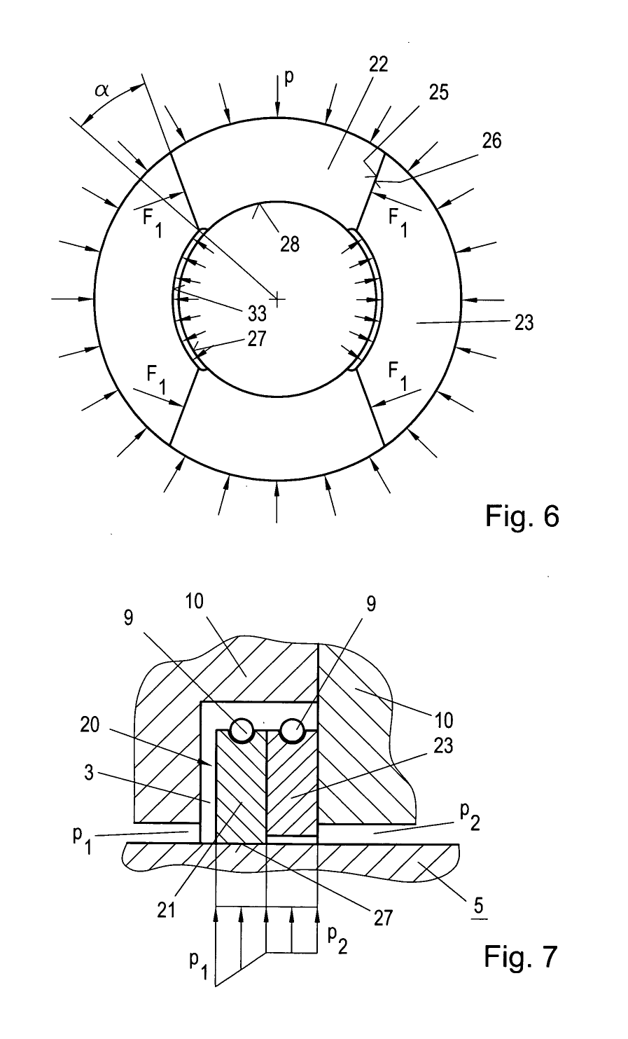

The function of the packing ring 20 according to the invention is explained as follows with reference to FIGS. 4 to 6. A pressure p acts upon the segments 21, 22, 23 of the packing ring 20 radially from the outside, which presses the first sealing segments 21 radially toward the inside. In a first phase the first sealing segments 21 therefore wear at a certain rate of wear until the gap h is closed, and the first sealing segments 21 abut the axial noses 24. The second sealing segments 22 are supported on the support segments 23 in this phase, and are relieved by the support segments 23, since a force F₁ is created due to the pressure p present and the angle a, which attempts to pull apart the sealing segments 22. Said force F₁ may therefore be adjusted by means of the angle α and optionally by means of the annular gap in the area of the support segments 23. As a result the second sealing segments 22 wear at a lower rate of wear than the first sealing segments 21 in this phase.

If the gap h is closed due to said different rates of wear, and the first sealing segments 21 abut the axial noses 24 (as illustrated in FIG. 5), the rate of wear of the first sealing segments 21 is reduced, since the first sealing segments 21 are now supported on the second sealing segments 22, however, the rate of wear of the second sealing segments 22 is simultaneously increased, as a force F₂ is created by means of the angle β, which presses the second sealing segments 22 toward the interior. Subsequently, a “mean” rate of wear is achieved, by means of which the first and second sealing segments 21, 22 receive further wear. However, since the two sealing segments 21, 22 are relieved (second sealing segment 22 by means of support segment 23, and first sealing segment 21 by means of second sealing segment 22) a low total rate of wear of the packing ring 20 is therefore achieved. The support segments 23 experience no wear at all. The wear behavior of the packing ring 20 may be adjusted in a simple and flexible manner by means of the angles α and β, and optionally by means of the annular gap such that the packing ring 20 is optimally configured for the respective use thereof.

For this purpose the gap h may be omitted. If available, the gap h serves to provide a type of break-in phase, in which the sealing surfaces 27 of the first sealing segments 21 are pressed against the counter sealing surface in a stronger manner in order to obtain a high sealing effect from the beginning by means of an adjustment of the sealing surface 27 achieved I this manner. Furthermore, it is ensured that the sealing effect is provided on the sealing surface 27 from the beginning regardless of the manufacture-related fluctuations in the dimensions of the segments 21, 22, 23. The annular gap formed by the support segments 23 may also be omitted. However, the same also serves to enable the sealing effect on the sealing surface 28 of the second sealing segments 22 as a function of the manufacture-related fluctuations in the dimensions of the segments 21, 22, 23 from the beginning.

The sealing segments 21, 22 wear in this manner until the first sealing segments 21 abut each other in circumferential direction. Furthermore, only the second sealing segments 22 would wear further. The material of the sealing segments 21, 22 available may therefore be utilized at a high degree before the packing ring 20 has to be exchanged.

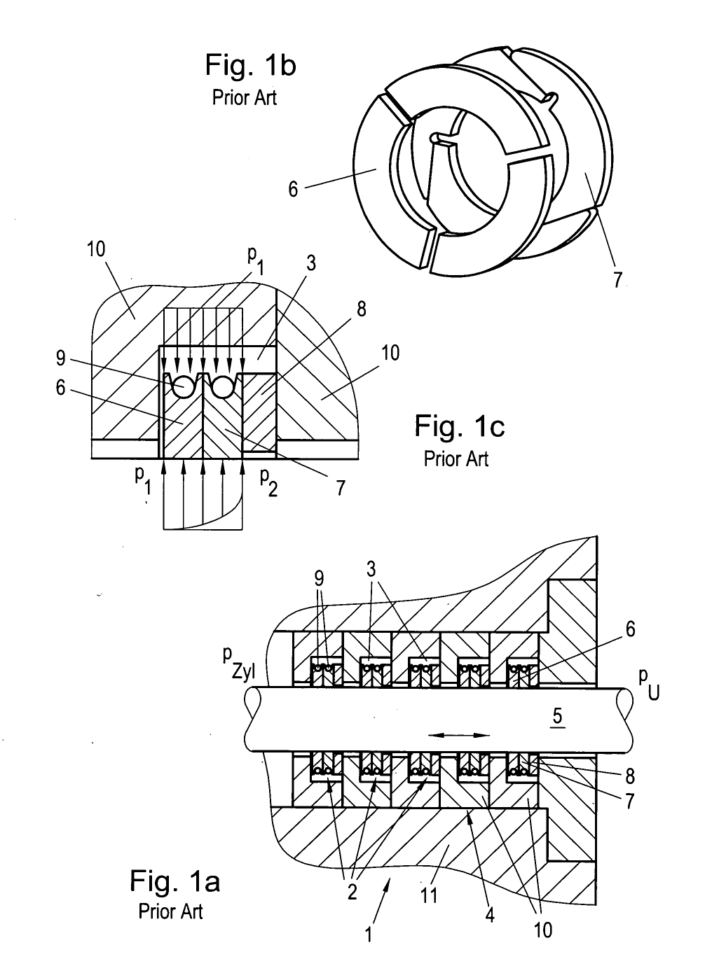

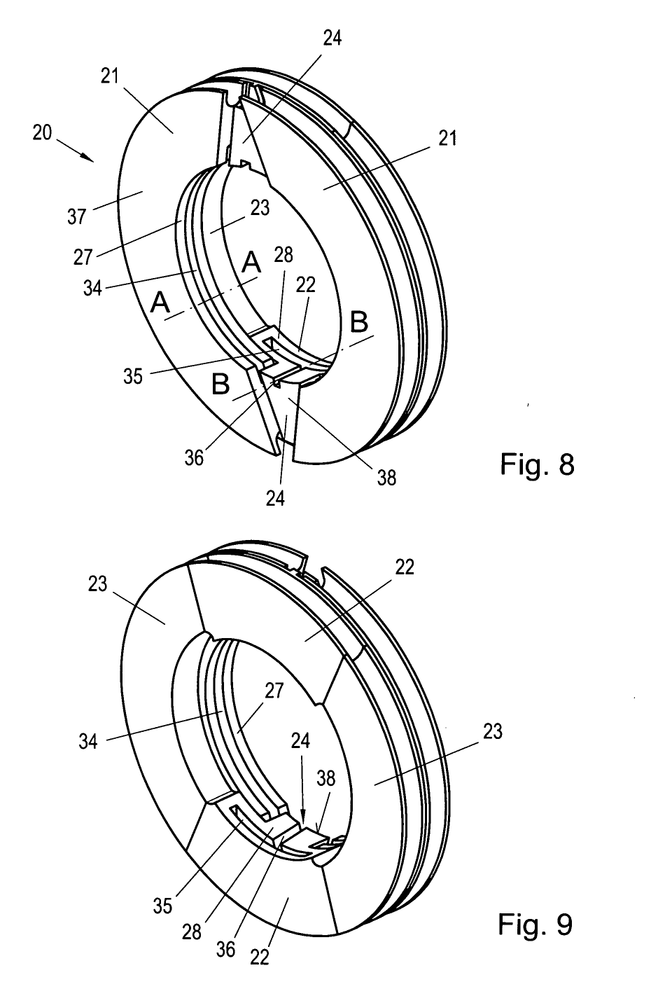

The use of a segmented packing ring 20 according to the invention described above is described based on FIG. 7 for the example of a seal of the piston rod 5 of a piston compressor. For this purpose the segmented packing ring 20 is again arranged in a chamber disk 10 of a pressure packing, wherein the first sealing segments 21 are arranged in a manner facing the high pressure p₁. Of course, a support ring could also be provided in the pressure packing on the side of the low pressure p₂, as described with regard to FIG. 1. The high pressure p₁ present in the packing chamber 3 acts upon the segments 21, 22, 23 of the packing ring 20 radially toward the outside. The sealing surface 27 of the support segments 23 are relieved by the annular gap, in which the low pressure p₂ is present. Otherwise the packing ring 20 operates as described above with regard to FIGS. 4 to 6.

A segmented packing ring 20 according to the invention may also be realized using a pressure compensation in a simple manner as described below with reference to FIGS. 8 and 9. The packing ring 20 illustrated corresponds to the packing ring 20 described above. Additionally, pressure compensation grooves 34 are incorporated on the first sealing segments 21 in the radial interior circumferential surface 27 in circumferential direction. As long as the nose 24 and the first sealing segments 21 do not yet abut each other in circumferential direction, the pressure present at the free front surface 37 of the first sealing segments 21 also acts on the pressure compensation groove 34. If the first sealing segments 21 abut the nose 24, the invention may provide that the pressure compensation no longer acts through the pressure compensation groove 34, in that the pressure compensation groove 34 is closed off by means of the nose 24, or in that the pressure compensation continues to act through the pressure compensation groove 34. In the latter case it must be provided that the pressure compensation groove 34 continues to be connected to the pressure present at the free front surface 37 of the first sealing segments 21. This may be realized, for example, by means of an axial groove leading away from the free front surface 37 and ending in the pressure compensation groove 34. As an alternative the nose 24 may also be axially offset so far that the pressure compensation groove 34 is not closed completely upon the abutment of the first sealing segments 21 to the nose 24.

Furthermore, the second sealing segments 22 may also be embodied in a pressure compensated manner. For this purpose pressure compensation grooves 35 extending in circumferential direction may be incorporated in the radial interior circumferential surface 28 of the second sealing segments 22, which extend in circumferential direction, but not across the entire circumferential length of the second sealing segments 22. Said pressure compensation grooves 35 are connected to the front surface 38 of the nose 24 by means of an axial groove 36. In this manner the pressure present at the free front surface 38 of the nose 24 also acts upon the pressure compensation groove 35. Instead of the axial groove 36 the pressure compensation groove 35 in the second sealing segment could also be connected to the radial exterior circumferential surface of the sealing segments via a radial bore, whereby the pressure acting there would also act upon the circumferential groove 35. However, it is of course also conceivable to embody the packing ring 20 with pressure compensation grooves 34 in the first sealing segments 21 only, or with pressure compensation grooves 35 in the second sealing segments 22 only. The acting surface pressing action between the packing ring 20 or the individual sealing segments 21, 22 of the packing ring 20 and the counter sealing surface, i.e. at the piston rod, may be reduced by means of such a pressure compensation, thus reducing the wear of the packing ring 20.

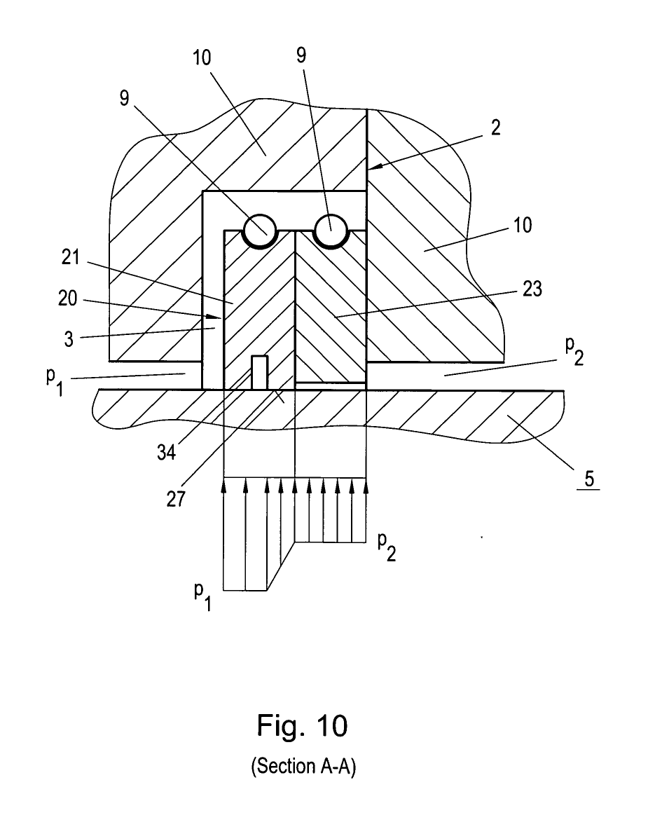

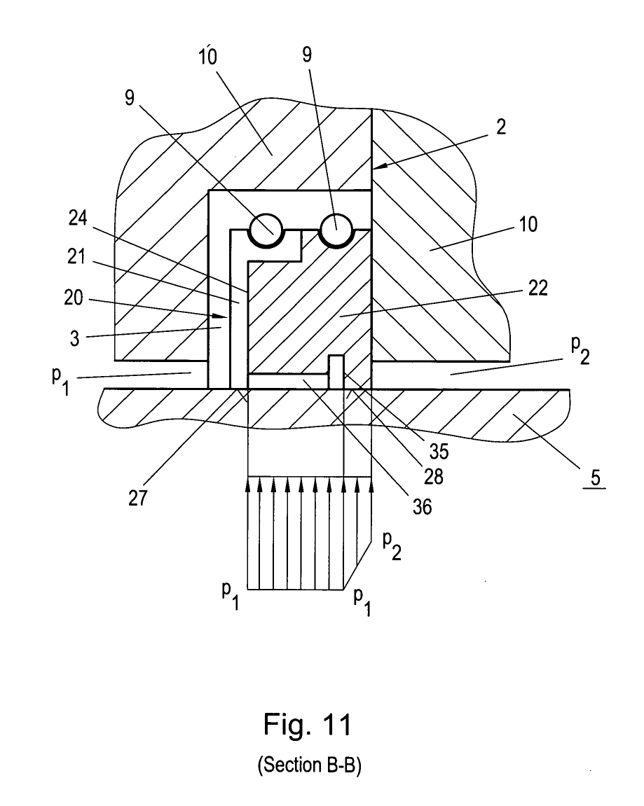

The effect of the pressure compensation grooves 34, 35 is shown based on the use of the packing ring as a seal of a piston rod 5 of a compressor with reference to FIG. 10. FIG. 10 shows a section across the packing ring 20 along the line A-A. The segmented packing ring 20 is again arranged in a chamber disk 10 of a pressure packing 2, wherein the first sealing segments 21 are arranged in a manner facing the high pressure p₁. Of course, a support ring could also be provided in the pressure packing on the side of the low pressure p₂, as described with regard to FIG. 1. The high pressure p₁ present in the packing chamber 3 acts upon the segments 21, 22, 23 of the packing ring 20 radially on the outside. The high pressure p₁ acts upon the radial interior at the sealing surfaces 27 at the first sealing segments 21 by means of the pressure compensation grooves 34. The high pressure p₁ also acts upon the pressure compensation grooves 35 at the second sealing segments 22 by means of the axial grooves 36 (or as an equivalent by means of a radial bore as described above). A pressure course is set there between the two pressure compensation grooves 34, 35.

1. A segmented packing ring, comprising a number of first sealing segments (21), a number of second sealing segments (22), and a number of support segments (23), wherein the support segments (23) and the second sealing segments (22) are arranged in an alternating successively abutting manner in the circumferential direction, and the first sealing segments (21) are arranged in a manner axially abutting the second sealing segments (22) and the support segments (23), and a nose (24) extending axially is provided on the second sealing segments (22), which is arranged in the circumferential direction between two adjacent first sealing segments (21).

2. The segmented packing ring according to claim 1, including a gap (h) in circumferential direction between an axial nose (24) and the adjacent first sealing segments (21).

3. The segmented packing ring according to claim 1, wherein the support segments (23) are embodied with a greater interior radius than the second sealing segments (22).

4. The segmented packing ring according to claim 1, wherein the circumferential front surfaces (25, 26) of the support segments (23) and of the second sealing segments (22) are tilted as opposed to a radial.

5. The segmented packing ring according to claim 1, wherein the circumferential front surfaces (29) of the axial nose (24) are embodied in a manner tapering from the radial interior toward the radial exterior.

6. The segmented packing ring according to claim 5, wherein the circumferential front surfaces (30) of the first sealing segments (21) are tilted as opposed to a radial in a manner corresponding to the wedge shape of the axial nose (24).

7. The segmented packing ring according to claim 1, wherein the axial width of the axial nose (24) is smaller than the axial width of the first sealing segments (21).

8. The segmented packing ring according to claim 1, including a pressure compensation groove (34) extending in circumferential direction is provided in the radial interior circumferential surface (27) of the first sealing segment (21).

9. The segmented packing ring according to claim 1, including a pressure compensation groove (35) extending in circumferential direction is provided in the radial interior circumferential surface (28) of the second sealing segment (22), which extends in circumferential direction across part of the circumferential length of the second sealing segment (22).

10. The segmented packing ring according to claim 9, wherein the pressure compensation groove (35) in the second sealing segment (22) is connected to the front surface (38) of the nose (24) by means of an axial groove (35), or to the exterior circumferential surface of the second sealing segment (22) by means of a radial recess.

11. A pressure packing consisting of a segmented packing ring (20) according to claim 1, being arranged in a packing chamber (3), wherein the axial nose (24) of the second sealing segments (22) faces the side having the high pressure (p₁).

12. A seal between a piston rod (5) of a compressor and a compressor housing having a number of pressure packings (2) axially successively arranged, consisting of a segmented packing ring (20) according to claim 1, which is arranged in a packing chamber (3), wherein the axial nose (24) of the second sealing segments (22) faces the side having the high pressure (p₁).
